(19) United States
(12) Patent Application Publication
(10) Pub. No.: US 2005/0272491 A1
(43) Pub. Date: Dec. 8, 2005

(54) Switch module for cellular phone

(76) Inventor: Bae Kyung Jeon, Ansan (KR)

Correspondence Address: Ladas & Parry, 26 West 61st Street, New York, NY, 10023, US

(21) Appl. No.: 10/899,585

(22) Filed: Jul. 27, 2004

(30) Foreign Application Priority Data
Jun. 7, 2004 (KR) 20-2004-0015873

(51) Int. Cl. H04M 1/00; H04B 1/38

(52) U.S. Cl. 455/575.8; 455/575.1; 455/550.1

(57) ABSTRACT

The present invention relates to a switch module for a cellular phone that is controlled in such a manner that a side key installed in a lateral side of a cellular phone for thereby conveniently changing a volume mode or a function mode by a one-touch method is pressurized. In the switch module for a cellular phone according to the present invention, a contact part of a connection terminal is bent with a certain elastic force and is always contacted with a pattern formed in a PCB installed in the interior of a cellular phone, for thereby enhancing an inter-connection rate between a pattern of the PCB and the connection terminal. Therefore, the life span of a cellular phone is extended, and a reliability of a product is enhanced.

### BACKGROUND OF THE INVENTION

1. Field of the Invention

The present invention relates to a switch module for a cellular phone that is controlled in such a manner that a side key installed in a lateral side of a cellular phone for thereby conveniently changing a volume mode or a function mode by an one-touch method is pressurized, and in particular to a switch module for a cellular phone in which a connection terminal contact part of a switch module contacting with a pattern formed in a PCB (Printed Circuit Board) installed in a cellular phone is elastically bent, for thereby increasing an inter-connection rate between a pattern of a PCB and a connection terminal, thus enhancing a reliability of a product.

2. Description of the Background Art

Generally, a cellular phone includes a keypad having various functions so that a user can select a telephone mode or a function mode based on a user's selection. A side key (a metal dome switch) is provided at a lateral side of a cellular phone, so that a user can easily change a certain function (such as volume control) among the multiple functions of the keypad based on a one-touch method.

As shown in FIGS. 1 and 2, the switch module for a conventional cellular phone includes a first connection terminal 5 that has a first connection part 4 downwardly extended below a first contact part 3 and is formed of a metal plate material wherein a first contact part 3 conductively contacting with a pattern 2 of a PCB 1 installed in a cellular phone is formed on an upper side of the same; and a second connection terminal 8 that has a second connection part 7 downwardly extended below a second contact part 6 and is symmetrically formed at both sides wherein a second contact part 6 is bent in the same direction as the first contact part 3 so as to conductively contact with a pattern 2 of the PCB 1.

The conventional switch module includes a body 10 that has a receiving groove 9 at both sides for receiving first and second connection parts 4 and 7 of the first and second connection terminals 5 and 8 wherein the first and second contact parts 3 and 6 of the first and second connection terminals 5 and 8 are molded and protruded from the upper side of the same; and a streamline shaped metal dome 11 that is engaged to the receiving groove 9 so that an edge portion is connected with the second connection part 7, wherein the metal dome 11 is elastically transformed when a user of a cellular phone pressurizes a center portion of the same for thereby electrically connecting the first and second connection parts 4 and 7.

The first and second contact parts 3 and 6 of the first and second connection terminals 5 and 8 always keep being contacted with respect to the pattern 2 of the PCB 1.

However, as shown in FIG. 2, in the conventional switch module structure, the first and second contact parts 3 and 6 are formed in a circular shape and are simply overlapped on the upper surface of the pattern 2.

Therefore, when a certain impact is applied to the cellular phone due to a user's mistake or the circular concave portions of the first and second contact parts 3 and 6 are slightly transformed based on the material characteristics of the first and second connection terminals 5 and 8, the pattern 2 and the first and second contact parts 3 and 6 may be disconnected, so that the PCB 1 and the first and second connection terminals 5 and 8 are elastically disconnected. Therefore, the user may forcibly apply an over pressure to the side key installed at the lateral side of the cellular phone, so that a corresponding element may be damaged.

### SUMMARY OF THE INVENTION

Accordingly, it is an object of the present invention to provide a switch module for a cellular phone that is capable of overcoming the problems encountered in the conventional art.

It is another object of the present invention to provide a switch module for a cellular phone that is capable of enhancing a reliability of a product by increasing an inter-connection rate between a pattern and a connection terminal in such a manner that a contact part of a connection terminal of a switch module contacting with a pattern of a PCB installed in a cellular phone is elastically bent.

It is further another object of the present invention to provide a switch module for a cellular phone capable of preventing a certain damage of a corresponding element occurring due to an over pressure applied to a side key installed at a lateral side of a cellular phone in such a manner that a connection terminal of a switch module always keeps being connected (initial state) with respect to a pattern of a PCB.

To achieve the above objects, in a switch module of a cellular phone controlled in such a manner that a side key installed at a lateral side of a PCB in a cellular phone and installed at a lateral side of a cellular phone is pressurized, there is provided an improved switch module for a cellular phone, comprising a first connection terminal that is bent with a certain elastic force in a direction that an end portion of a first contact part contacting with a pattern of the PCB pressurizes the pattern and that has a first connection part downwardly extended below the first contact part; a second connection terminal that is bent with a certain elastic force in a direction that an end portion of a second contact part contacting with a pattern of the PCB pressurizes the pattern and that has a second connection part that downwardly extended below the second contact part and symmetrically formed at the left and right sides; a body in which the first and second connection terminals are insert-molded so that the first and second contact parts are upwardly protruded, wherein a receiving groove is formed at both sides of the body for receiving the first and second connection parts therein; and a metal dome that is coupled in the receiving groove so that an edge of the same is always connected with the second connection part and that electrically connects the first and second connection parts in such a manner that the metal dome is downwardly pressed when a user presses a center portion of the same.

### BRIEF DESCRIPTION OF THE DRAWINGS

The present invention will become better understood with reference to the accompanying drawings which are given only by way of illustration and thus are not limitative of the present invention, wherein;

FIG. 1 is a partial cut-away view illustrating a switch module of a conventional cellular phone;

FIG. 2 is a view illustrating the use of a switch module of a conventional cellular phone according to the present invention;

FIG. 3 is a partial cut-away perspective view illustrating a switch module for a cellular phone according to an embodiment of the present invention;

FIG. 4 is a perspective view illustrating a switch module for a cellular phone according to an embodiment of the present invention;

FIG. 5 is a view illustrating the use of a switch module for a cellular phone according to an embodiment of the present invention;

FIG. 6 is a cross sectional view taken along line A-A of FIG. 4;

FIG. 7 is a perspective view illustrating a switch module for a cellular phone according to another embodiment of the present invention; and

FIG. 8 is a perspective view illustrating a switch module for a cellular phone according to further embodiment of the present invention.

### DETAILED DESCRIPTION OF THE PREFERRED EMBODIMENTS

The preferred embodiments of the present invention will be described with reference to the accompanying drawings.

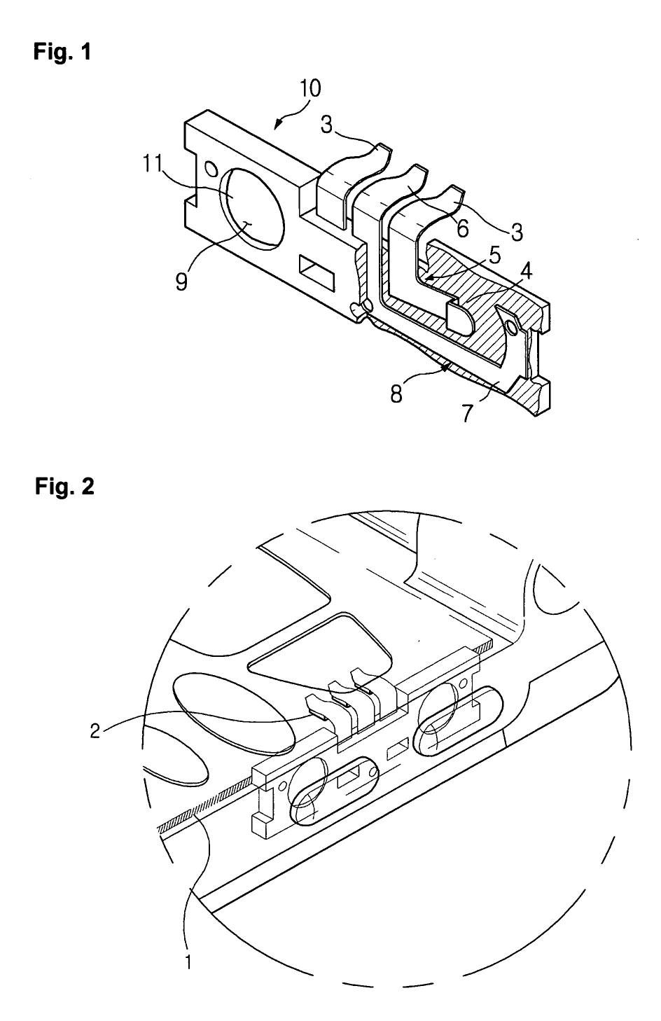

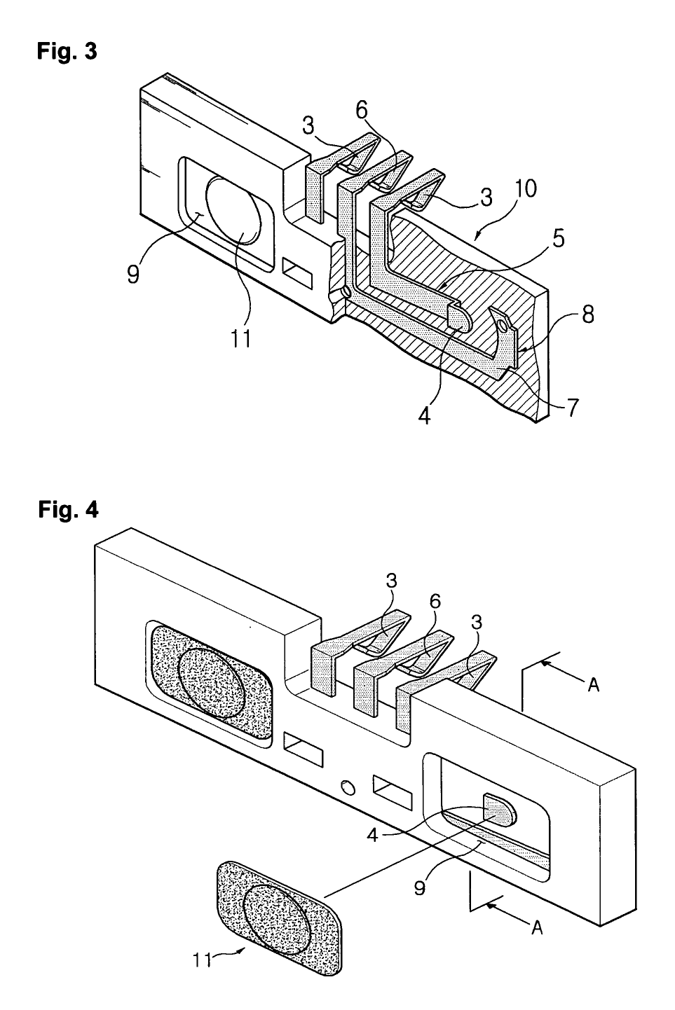

FIGS. 3 through 6 are perspective views according to an embodiment of the present invention. As shown therein, the device according to the present invention is installed in a lateral side of a PCB (Printed Circuit Board) installed in the interior of a cellular phone and is adapted to a switch module controlled based on a push of a side key exposed on a lateral surface of a cellular phone. The descriptions of the elements having the same reference numbers as in FIGS. 1 and 2 will be omitted.

The switch module for a cellular phone according to the present invention includes a first connection terminal 5 that is bent and has an elastic force in a direction that an end portion of a first contact part 3 pressurizes a pattern 2 so that the first connection terminal 5 always contacts with the pattern 2 of a PCB (Printed Circuit Board) 1 and that has a first connection part 4 downwardly extended at an angle of about 90° with respect to the first contact part 3 wherein the first connection terminal 5 is formed of a metal conductive plate; and a second connection terminal 8 that is bent and has an elastic force in a direction that an end portion of a second contact part 6 pressurizes the pattern so that the second connection terminal 8 always contacts with the pattern 2 and that has a second connection part 7 downwardly extending at an angle of about 90° with respect to the second contact part 6 and is symmetrically formed at both sides.

The first and second connection terminals 5 and 8 are insert-molded so that the first and second contact parts 3 and 6 are upwardly protruded. There is provided a body 10 having a rectangular receiving groove 9 at left and right sides wherein the first and second connection parts 4 and 7 are received therein, respectively. There is further provided a plate shaped conductive and elastic metal dome 11 that corresponds to the shape of the receiving groove 9 so that an edge portion of the same always contacts with the second connection part 7 and is engaged to the receiving groove 9 (at this time, the center portion is distanced from the first connection part 4), wherein the metal dome 11 electrically connects the first and second connection parts 4 and 7 based on a connection with the first connection part 4 when the user pressurizes the center portion of the same and is pressed (elastic transformation).

At this time, in the case that the switch module is installed in a lateral side of the PCB 1 installed in the interior of the cellular phone, the first and second contact parts 3 and 6 of the first and second connection terminals 5 and 8 are protruded from the upper surface of the body 10 so that the switch module does not interfere with the neighboring parts, and the size of the body of the cellular phone is decreased in maximum.

The operation and effect of the present invention will be described. An example of the use of the switch module for a cellular phone according to the present invention will be described with reference to the accompanying drawings.

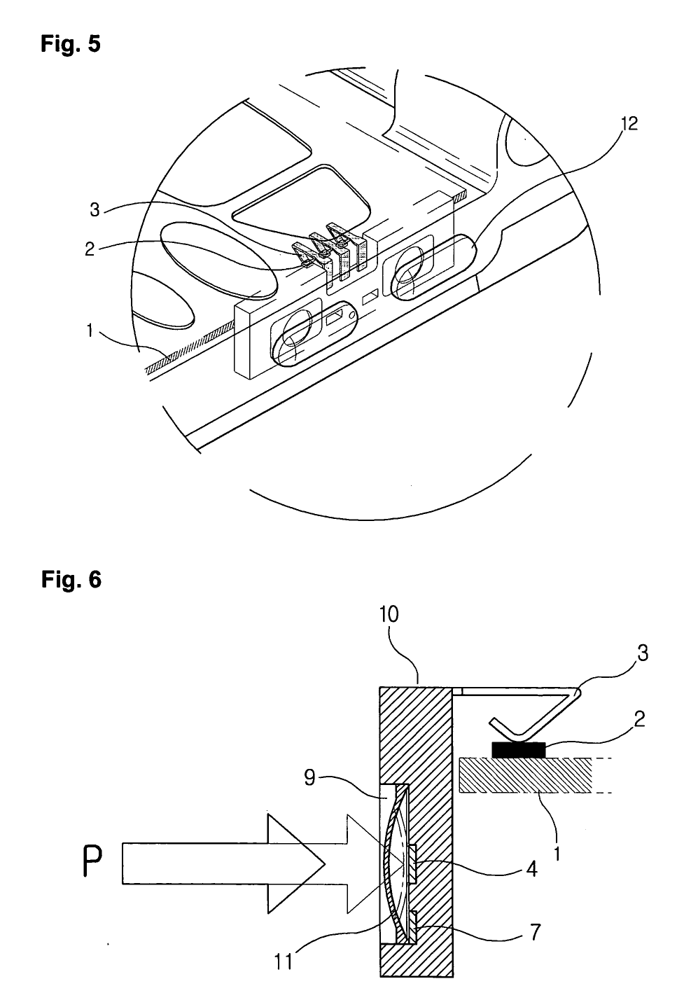

As shown in FIGS. 5 and 6, when the user pressurizes the side key 12 installed at a lateral side of the cellular phone, the metal dome 11 engaged to the receiving groove 9 formed in the body 10 of the switch module is pressurized.

Namely, as the center of the metal dome 11 is pressurized when an external force is applied thereto by the user, the center portion of the same is pushed (shown by the imaginary line in FIG. 6) and contacts with the first connection part 4, so that the second connection part 7 of the second connection terminal 8 positioned at the edge of the receiving groove 9 is electrically connected with the first connection part 4 of the first connection terminal 5 positioned at the center of the receiving groove 9.

At this time, since the first and second contact parts 3 and 6 of the first and second connection terminals 5 and 8 are always connected with the pattern 2 of the PCB 1, keeping the initial contact states. Therefore, it is possible to enhance a connection rate between the pattern 2 and the first and second connection terminals 5 and 8.

Namely, since the ends of the first and second contact parts 3 and 6 are bent and have an elastic force in a direction that the ends of the same pressurize the pattern 2. Therefore, even when a certain external impact is applied to the cellular phone by a user's mistake or the bent portion is slightly recovered and transformed due to the characteristics of the materials of the first and second connection terminals 5 and 8, the first and second contact parts 3 and 6 keep the state contacted with the pattern 2.

In the case that the external force applied to the metal dome 11 is removed, the metal dome 11 returns to its original state by an elastic recovery force (at this time, the edges of the metal dome 11 keep the initial state connected with the second connection part 7 of the second connection terminal 8), and the center of the metal dome 11 is separated from the first connection part 4 of the first connection terminal 5, so that the first connection part 4 of the first connection terminal 5 is elastically disconnected from the second connection part 7 of the second connection terminal 8.

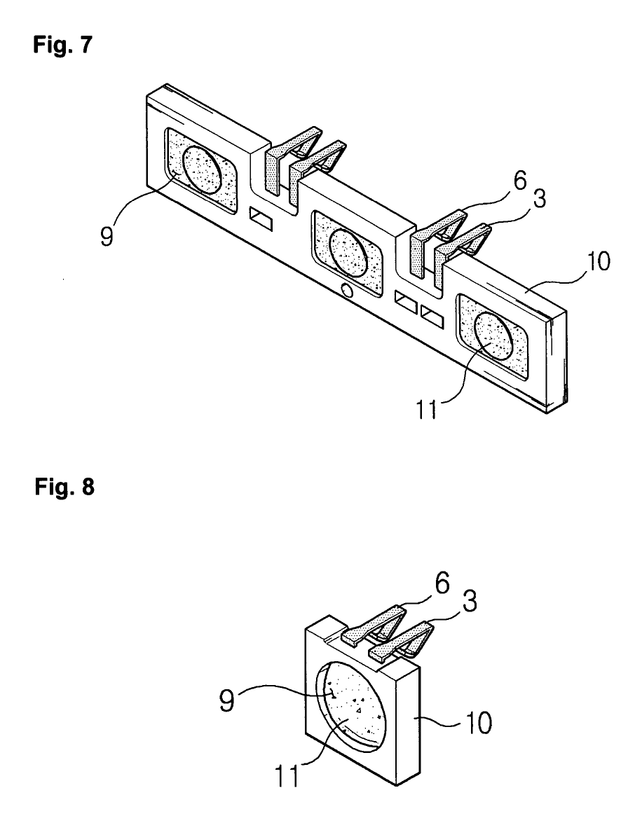

FIG. 7 is a perspective view of another embodiment of the present invention. As shown therein, there is provided a switch module for a cellular phone having three side keys 12 installed at a lateral side of the cellular phone. Three metal domes 11 corresponding to three side keys 12 are provided in the body 10. The construction of FIG. 7 is similar with the constructions of FIGS. 3 through 6. Therefore, the detailed descriptions thereon will be described.

FIG. 8 is a view of further another embodiment of the present invention. In this embodiment of the present invention, there is provided a switch module for a cellular phone having one side key 12 installed at a lateral side of the cellular phone. One metal dome 11 corresponding to one side key 12 is provided in the body 10. In this embodiment of the present invention, since the construction of FIG. 8 is similar with the constructions of FIGS. 3 through 6, the detailed descriptions thereon will be omitted.

As described above, an inter-connection rate between a pattern and a connection terminal is enhanced in such a manner that a contact part of a connection terminal of a switch module contacting with a pattern of a PCB installed in the interior of a cellular phone is bent and has a certain elastic force, so that it is possible to enhance a reliability of a product.

In addition, in the present invention, since a connection terminal of a switch module always keeps an electrically connected state with respect to a pattern of a PCB, it is possible to prevent a user from over-pressing a side key installed at a lateral side of a cellular phone, so that the life span of a corresponding part is significantly enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a switch module of a cellular phone controlled in such a manner that a side key installed at a lateral side of a PCB in a cellular phone and installed at a lateral side of a cellular phone is pressurized, an improved switch module for a cellular phone, comprising:
a first connection terminal that is bent with a certain elastic force in a direction that an end portion of a first contact part contacting with a pattern of the PCB pressurizes the pattern and that has a first connection part downwardly extended below the first contact part;
a second connection terminal that is bent with a certain elastic force in a direction that an end portion of a second contact part contacting with a pattern of the PCB pressurizes the pattern and that has a second connection part that downwardly extended below the second contact part and symmetrically formed at the left and right sides;
a body in which the first and second connection terminals are insert-molded so that the first and second contact parts are upwardly protruded, wherein a receiving groove is formed at both sides of the body for receiving the first and second connection parts therein; and
a metal dome that is coupled in the receiving groove so that an edge of the same is always connected with the second connection part and that electrically connects the first and second connection parts in such a manner that said metal dome is downwardly pressed when a user presses a center portion of the same.
